(19) United States
(12) Patent Application Publication
(10) Pub. No.: US 2026/0343095 A1
(43) Pub. Date: Oct. 29, 2026

(54) ADAPTIVE IMAGE PROCESSING USING PREDICTED IMAGE STABILIZATION PARAMETERS

(71) Applicant: QUALCOMM Incorporated, San Diego, CA (US)

(72) Inventors: Eliad Tsairi, Hof HaCarmel (IL); Ron Gaizman, Hof HaCarmel (IL); Ori Spier, Nachsholim (IL); Elia Pony, Kiryat Bialik (IL); Amani Shhadi Sammar, Majd El-Kurum (IL)

(21) Appl. No.: 19/191,942

(22) Filed: Apr. 28, 2025

(51) Int. Cl. H04N 23/68; H04N 23/741; H04N 23/81

(52) U.S. Cl. CPC H04N 23/683; H04N 23/6812; H04N 23/741; H04N 23/81

(57) ABSTRACT

This disclosure provides systems, methods, and devices that predict future parameters of an image stabilization system in an image capture device to enhance image processing. In one aspect, an image capture device is configured to receive sensor data indicative of motion during a process to capture image frames. Predicted future parameters may be determined for the image stabilization system based on the sensor data, and image frames may be processed using these predicted parameters and at least a subset of the captured frames. Other aspects are provided. For example, predicted future motion data and activity classifications may be determined to refine the predicted future parameters. An image stabilization control process may be applied, and may utilize a physical model of the image stabilization system. Predictions may be adjusted when near operational boundaries or based on confidence levels associated with the predictions.

### TECHNICAL FIELD

Aspects of the present disclosure relate generally to image processing, and more particularly, to image stabilization techniques. Some features may enable and provide improved image processing, including adjusting image processing based on predicted image stabilization parameters to reduce latency and improve image quality.

### INTRODUCTION

Image capture devices are devices that can capture one or more digital images, whether still images for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The present techniques relate to systems and methods for predicting future parameters of an image stabilization system within an image capture device. By analyzing sensor data indicative of device motion—such as data from gyroscopes, accelerometers, and magnetometers—a processor may anticipate how the device will move and may then determine predicted future parameters of the image stabilization system based on this anticipated motion.

These predictions enable image capture devices to process image frames proactively, adjusting for motion before it occurs and reducing processing latency. The system may adjust processing strategies based on a confidence level associated with the predictions, and may update predictions dynamically by comparing them with actual parameters once available. The techniques also involve adapting prediction horizons and utilizing physical models of the image stabilization system, improving the accuracy and efficiency of image stabilization in various operational scenarios.

In one aspect, a system includes a memory and at least one processor coupled to the memory, the at least one processor configured to receive sensor data indicative of motion of an image capture device during a process to capture one or more image frames, determine, based at least in part on the sensor data, one or more predicted future parameters for an image stabilization system of the image capture device, and determine one or more processed image frames by aligning at least a first image frame and a second image frame of the one or more image frames based on the one or more predicted future parameters.

In another aspect, a method includes receiving sensor data indicative of motion of an image capture device during a process to capture one or more image frames, determining, based at least in part on the sensor data, one or more predicted future parameters for an image stabilization system of the image capture device, and determining one or more processed image frames by aligning at least a first image frame and a second image frame of the one or more image frames based on the one or more predicted future parameters.

In a further aspect, a non-transitory computer-readable medium stores instructions which, when executed by a processor, cause the processor to receive sensor data indicative of motion of an image capture device during a process to capture one or more image frames, determine, based at least in part on the sensor data, one or more predicted future parameters for an image stabilization system of the image capture device, and determine one or more processed image frames by aligning at least a first image frame and a second image frame of the one or more image frames based on the one or more predicted future parameters.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The image processing techniques described herein may involve digital cameras having image sensors and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more image sensors and determine one or more image frames from the one or more image sensors to generate a view of a scene in an output image frame. The output image frame may be part of a sequence of image frames forming a video sequence. The video sequence may include other image frames received from the image sensor or other images sensors.

In an example application, the image signal processor (ISP) may receive an instruction to capture a sequence of image frames in response to the loading of software, such as a camera application, to produce a preview display from the image capture device. The image signal processor may be configured to produce a single flow of output image frames, based on images frames received from one or more image sensors. The single flow of output image frames may include raw image data from an image sensor, binned image data from an image sensor, or corrected image data processed by one or more algorithms within the image signal processor. For example, an image frame obtained from an image sensor, which may have performed some processing on the data before output to the image signal processor, may be processed in the image signal processor by processing the image frame through a post-processing engine (PE) and/or other image processing circuitry for performing one or more of tone mapping, portrait lighting, contrast enhancement, gamma correction, etc. The output image frame from the ISP may be stored in memory and retrieved by an application processor executing the camera application, which may perform further processing on the output image frame to adjust an appearance of the output image frame and reproduce the output image frame on a display for view by the user.

After an output image frame representing the scene is determined by the image signal processor and/or determined by the application processor, such as through image processing techniques described in various embodiments herein, the output image frame may be displayed on a device display as a single still image and/or as part of a video sequence, saved to a storage device as a picture or a video sequence, transmitted over a network, and/or printed to an output medium. For example, the image signal processor (ISP) may be configured to obtain input frames of image data (e.g., pixel values) from the one or more image sensors, and in turn, produce corresponding output image frames (e.g., preview display frames, still-image captures, frames for video, frames for object tracking, etc.). In other examples, the image signal processor may output image frames to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. Generally, the image signal processor (ISP) may obtain incoming frames from one or more image sensors and produce and output a flow of output frames to various output destinations.

In some aspects, the output image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The device may include one, two, or more image sensors, such as a first image sensor. When multiple image sensors are present, the image sensors may be differently configured. For example, the first image sensor may have a larger field of view (FOV) than the second image sensor, or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. Any of these or other configurations may be part of a lens cluster on a mobile device, such as where multiple image sensors and associated lenses are located in offset locations on a frontside or a backside of the mobile device. Additional image sensors may be included with larger, smaller, or same field of views. The image processing techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors) and time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device for performing image capture from one or more image sensors.

FIG. 2 is a block diagram illustrating an example data flow path for image data processing in an image capture device according to one or more embodiments of the disclosure.

FIG. 3 depicts a block diagram of an image stabilization process according to one aspect of the present disclosure.

FIG. 4 depicts a block diagram of a system for adaptive image processing using predicted image stabilization parameters according to one aspect of the present disclosure.

FIG. 5 depicts a method for adaptive image processing using predicted image stabilization parameters according to one aspect of the present disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

Optical Image Stabilization (OIS) may be used in image capture devices to reduce blur caused by device motion during image acquisition, and may additionally provide global stabilization. Traditional OIS systems rely on real-time sensor data to adjust optical elements, such as movable lenses or sensors, to counteract movement. However, these systems may face challenges related to latency and processing delays. Specifically, image processing tasks often have to wait for all necessary sensor and position data to be available before proceeding. This waiting period increases the overall latency, leading to delays in image processing pipelines and affecting real-time performance.

Moreover, predicting future parameters of the image stabilization system is complicated by several factors. Physical limitations of the hardware, such as operational boundaries and mechanical constraints, can change the system's response characteristics near its limits. Additionally, device movements can be erratic and unpredictable, especially in scenarios involving rapid or sudden motions. Existing techniques may not adequately account for these variables, resulting in less accurate motion compensation and degraded image quality.

One solution to this problem is to predict future parameters of the image stabilization system based on sensor data and adapt subsequent image processing based on the predicted future parameters. By utilizing sensor data from devices like gyroscopes, accelerometers, and magnetometers, an image capture device can determine predicted future motion data. This may include applying prediction processes, such as machine learning models or polynomial fitting techniques, to estimate how the device will move in the near future.

A confidence level associated with these predictions may also be determined and used to adjust subsequent image processing tasks. For instance, with high confidence levels, the image processing may proceed without waiting for actual position data, reducing latency. When confidence is low, the image processing may be delayed. Relatedly, a prediction horizon—the time frame over which predictions are made—may be adjusted to improve accuracy. The prediction may be adjusted based on proximity to operational boundaries and adapting the prediction process based on physical characteristics of the image stabilization system.

Particular implementations of the subject matter described in this disclosure may be implemented to realize one or more of the following potential advantages or benefits. In some aspects, the present disclosure provides techniques for predicting future parameters of an image stabilization system that may be particularly beneficial in enhancing real-time image processing performance and resource optimization. For example, by proactively determining predicted parameters based on sensor data and adjusting processing strategies according to confidence levels, the system reduces the latency typically associated with waiting for actual position data. This anticipatory approach allows the image processing pipeline to begin earlier, leading to smoother real-time previews and recordings. The ability to configure image processing units in advance using predicted parameters minimizes delays and ensures that image stabilization and enhancement processes keep pace with the capture of image frames.

Additionally, these techniques improve the functioning of the image capture device by optimizing resource utilization and adapting to changing operational conditions. By distributing tasks across multiple processors—such as a microcontroller dedicated to motion prediction and a high-level processor handling image processing—the system ensures efficient processing without overloading computational resources. The adaptive adjustment of the prediction horizon based on system requirements and prediction accuracy allows the device to balance computational load with performance needs. Furthermore, the ability to update predictions and processing strategies dynamically based on actual parameters and confidence levels enhances the robustness of the system, maintaining high image quality across various operating conditions by accounting for changes in hardware characteristics over time.

For end users, these techniques offer significant benefits in terms of image quality and user experience. By reducing latency in the image processing pipeline, users experience immediate stabilization effects in live previews and video recordings, resulting in smoother and more professional-looking content. The proactive motion compensation may reduce image blur and jitter, even in challenging conditions involving rapid or unpredictable movements. This enhances the usability of the camera in mobile devices, enabling users to capture high-quality images and videos without the need for additional equipment or manual adjustments. The system's ability to maintain temporal and global consistency and perform advanced processing like temporal noise reduction and depth estimation further enriches the visual quality of the captured content, providing users with clearer images and more accurate representations of their environment. In particular, because distortion correction for a current image frame may be corrections applied to a previous image frame, global alignment may be achieved without requiring additional processing steps, allowing processing like high-dynamic-range (HDR) fusion and motion-compensated temporal filtering (MCTF) blocks to begin processing immediately without an extra alignment pass.

Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

An example device for capturing image frames using one or more image sensors, such as a smartphone, may include a configuration of one, two, three, four, or more cameras on a backside (e.g., a side opposite a primary user display) and/or a front side (e.g., a same side as a primary user display) of the device. The devices may include one or more image signal processors (ISPs), Computer Vision Processors (CVPs) (e.g., AI engines), or other suitable circuitry for processing images captured by the image sensors. The one or more image signal processors (ISP) may store output image frames in a memory and/or otherwise provide the output image frames to processing circuitry (such as through a bus). The processing circuitry may perform further processing, such as for encoding, storage, transmission, or other manipulation of the output image frames.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including, coupled to, or otherwise processing data from one, two, or more image sensors capable of capturing image frames (or “frames”). The terms “output image frame” and “corrected image frame” may refer to image frames that have been processed by any of the discussed techniques. Further, aspects of the present disclosure may be implemented in devices having or coupled to image sensors of the same or different capabilities and characteristics (such as resolution, shutter speed, sensor type, and so on). Further, aspects of the present disclosure may be implemented in devices for processing image frames, whether or not the device includes or is coupled to the image sensors, such as processing devices that may retrieve stored images for processing, including processing devices present in a cloud computing system.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU)) configured to perform the recited function through hardware, software, or a combination of hardware configured by software.

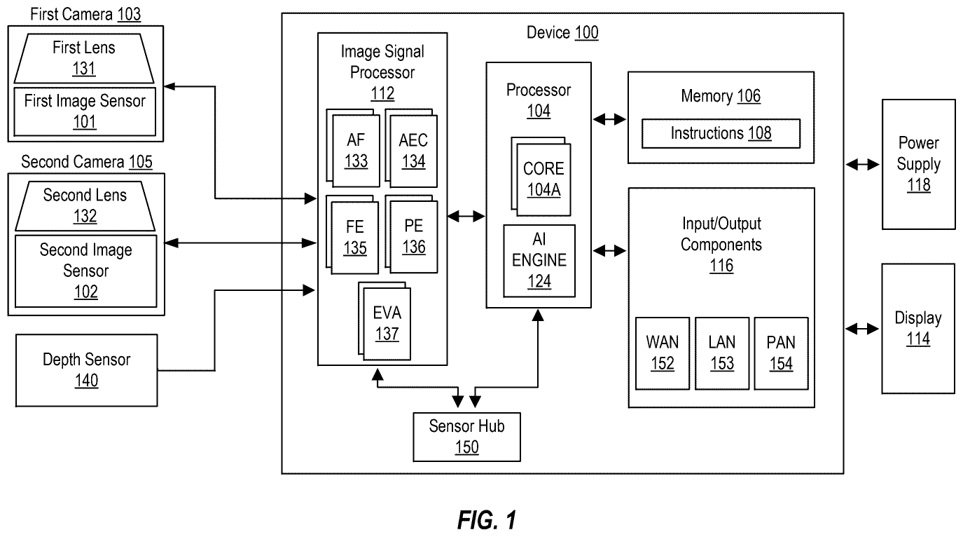

FIG. 1 shows a block diagram of an example device 100 for performing image capture from one or more image sensors. The device 100 may include, or otherwise be coupled to, an image signal processor 112 for processing image frames from one or more image sensors, such as a first image sensor 101, a second image sensor 102, and a depth sensor 140. In some implementations, the device 100 also includes or is coupled to a processor 104 and a memory 106 storing instructions 108. The device 100 may also include or be coupled to a display 114 and input/output (I/O) components 116. I/O components 116 may be used for interacting with a user, such as a touch screen interface and/or physical buttons.

I/O components 116 may also include network interfaces for communicating with other devices, including a wide area network (WAN) adaptor 152, a local area network (LAN) adaptor 153, and/or a personal area network (PAN) adaptor 154. An example WAN adaptor is a 4G LTE or a 5G NR wireless network adaptor. An example LAN adaptor 153 is an IEEE 802.11 WiFi wireless network adapter. An example PAN adaptor 154 is a Bluetooth wireless network adaptor. Each of the adaptors 152, 153, and/or 154 may be coupled to an antenna, including multiple antennas configured for primary and diversity reception and/or configured for receiving specific frequency bands.

The device 100 may further include or be coupled to a power supply 118 for the device 100, such as a battery or a component to couple the device 100 to an energy source. The device 100 may also include or be coupled to additional features or components that are not shown in FIG. 1. In one example, a wireless interface, which may include a number of transceivers and a baseband processor, may be coupled to or included in WAN adaptor 152 for a wireless communication device. In a further example, an analog front end (AFE) to convert analog image frame data to digital image frame data may be coupled between the image sensors 101 and 102 and the image signal processor 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and/or distance may be included in generated motion data. In some aspects, a gyroscope in an electronic image stabilization system (EIS) may be coupled to the sensor hub or coupled directly to the image signal processor 112. In another example, a non-camera sensor may be a global positioning system (GPS) receiver.

The image signal processor 112 may receive image data, such as used to form image frames. In one embodiment, a local bus connection couples the image signal processor 112 to image sensors 101 and 102 of a first camera 103 and second camera 105, respectively. In another embodiment, a wire interface couples the image signal processor 112 to an external image sensor. In a further embodiment, a wireless interface couples the image signal processor 112 to the image sensor 101, 102.

The first camera 103 may include the first image sensor 101 and a corresponding first lens 131. The second camera may include the second image sensor 102 and a corresponding second lens 132. Each of the lenses 131 and 132 may be controlled by an associated autofocus (AF) algorithm 133 executing in the ISP 112, which adjust the lenses 131 and 132 to focus on a particular focal plane at a certain scene depth from the image sensors 101 and 102. The AF algorithm 133 may be assisted by depth sensor 140.

The first image sensor 101 and the second image sensor 102 are configured to capture one or more image frames. Lenses 131 and 132 focus light at the image sensors 101 and 102, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors.

That is, each image sensor may be configured through hardware configuration and/or software settings to obtain different, but overlapping, field of views. In one configuration, the image sensors are configured with different lenses with different magnification ratios that result in different fields of view. The sensors may be configured such that a UW sensor has a larger FOV than a W sensor, which has a larger FOV than a T sensor, which has a larger FOV than a UT sensor. For example, a sensor configured for wide FOV may capture fields of view in the range of 64-84 degrees, a sensor configured for ultra-side FOV may capture fields of view in the range of 100-140 degrees, a sensor configured for tele FOV may capture fields of view in the range of 10-30 degrees, and a sensor configured for ultra-tele FOV may capture fields of view in the range of 1-8 degrees.

The camera 103 may be a variable aperture (VA) camera in which the aperture can be controlled to a particular size. Example aperture sizes are f/2.0, f/2.8, f/3.2, f/8.0, etc. Larger aperture values correspond to smaller aperture sizes, and smaller aperture values correspond to larger aperture sizes. The camera 103 may have different characteristics based on the current aperture size, such as a different depth of focus (DOF) at different aperture sizes.

The image signal processor 112 processes image frames captured by the image sensors 101 and 102. While FIG. 1 illustrates the device 100 as including two image sensors 101 and 102 coupled to the image signal processor 112, any number (e.g., one, two, three, four, five, six, etc.) of image sensors may be coupled to the image signal processor 112. In some aspects, depth sensors such as depth sensor 140 may be coupled to the image signal processor 112, and output from the depth sensors are processed in a similar manner to that of image sensors 101 and 102. Example depth sensors include active sensors, including one or more of indirect Time of Flight (iToF), direct Time of Flight (dToF), light detection and ranging (Lidar), mmWave, radio detection and ranging (Radar), and/or hybrid depth sensors, such as structured light. In embodiments without a depth sensor 140, similar information regarding depth of objects or a depth map may be generated in a passive manner from the disparity between two image sensors (e.g., using depth-from-disparity or depth-from-stereo), phase detection auto-focus (PDAF) sensors, or the like. In addition, any number of additional image sensors or image signal processors may exist for the device 100.

In some embodiments, the image signal processor 112 may execute instructions from a memory, such as instructions 108 from the memory 106, instructions stored in a separate memory coupled to or included in the image signal processor 112, or instructions provided by the processor 104. In addition, or in the alternative, the image signal processor 112 may include specific hardware (such as one or more integrated circuits (ICs)) configured to perform one or more operations described in the present disclosure. For example, the image signal processor 112 may include one or more front ends (FEs) 135, one or more post-processing engines 136 (PEs), one or more auto exposure compensation (AEC) 134 engines, and/or one or more engines for video analytics (EVAs). The AF 133, AEC 134, FE 135, PE 136, and EVA 137 may each include application-specific circuitry, be embodied as software code executed by the ISP 112, and/or a combination of hardware and software code executing on the ISP 112.

In some implementations, the memory 106 may include a non-transient or non-transitory computer readable medium storing computer-executable instructions 108 to perform all or a portion of one or more operations described in this disclosure. In some implementations, the instructions 108 include a camera application (or other suitable application) to be executed by the device 100 for generating images or videos. The instructions 108 may also include other applications or programs executed by the device 100, such as an operating system and specific applications other than for image or video generation. Execution of the camera application, such as by the processor 104, may cause the device 100 to generate images using the image sensors 101 and 102 and the image signal processor 112. The memory 106 may also be accessed by the image signal processor 112 to store processed frames or may be accessed by the processor 104 to obtain the processed frames. In some embodiments, the device 100 does not include the memory 106. For example, the device 100 may be a circuit including the image signal processor 112, and the memory may be outside the device 100. The device 100 may be coupled to an external memory and configured to access the memory for writing output frames for display or long-term storage. In some embodiments, the device 100 is a system-on-chip (SoC) that incorporates the image signal processor 112, the processor 104, the sensor hub 150, the memory 106, and input/output components 116 into a single package.

In some embodiments, at least one of the image signal processor 112 or the processor 104 executes instructions to perform various operations described herein, including image stabilization operations. For example, execution of the instructions can instruct the image signal processor 112 to begin or end capturing an image frame or a sequence of image frames, in which the capture includes image stabilization as described in embodiments herein. In some embodiments, the processor 104 may include one or more general-purpose processor cores 104A capable of executing scripts or instructions of one or more software programs, such as instructions 108 stored within the memory 106. For example, the processor 104 may include one or more application processors configured to execute the camera application (or other suitable application for generating images or video) stored in the memory 106.

In executing the camera application, the processor 104 may be configured to instruct the image signal processor 112 to perform one or more operations with reference to the image sensors 101 or 102. For example, a camera application executing on processor 104 may receive a user command to begin a video preview display upon which a video comprising a sequence of image frames is captured and processed from one or more image sensors 101 or 102 through the image signal processor 112. Image processing to generate “output” or “corrected” image frames, such as according to techniques described herein, may be applied to one or more image frames in the sequence. Execution of instructions 108 outside of the camera application by the processor 104 may also cause the device 100 to perform any number of functions or operations. In some embodiments, the processor 104 may include ICs or other hardware (e.g., an artificial intelligence (AI) engine 124 or other co-processor) to offload certain tasks from the cores 104A. The AI engine 124 may be used to offload tasks related to, for example, face detection and/or object recognition. In some other embodiments, the device 100 does not include the processor 104, such as when all of the described functionality is configured in the image signal processor 112.

In some embodiments, the display 114 may include one or more suitable displays or screens allowing for user interaction and/or to present items to the user, such as a preview of the image frames being captured by the image sensors 101 and 102. In some embodiments, the display 114 is a touch-sensitive display. The I/O components 116 may be or include any suitable mechanism, interface, or device to receive input (such as commands) from the user and to provide output to the user through the display 114. For example, the I/O components 116 may include (but are not limited to) a graphical user interface (GUI), a keyboard, a mouse, a microphone, speakers, a squeezable bezel, one or more buttons (such as a power button), a slider, a switch, and so on.

While shown to be coupled to each other via the processor 104, components (such as the processor 104, the memory 106, the image signal processor 112, the display 114, and the I/O components 116) may be coupled to each another in other various arrangements, such as via one or more local buses, which are not shown for simplicity. While the image signal processor 112 is illustrated as separate from the processor 104, the image signal processor 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

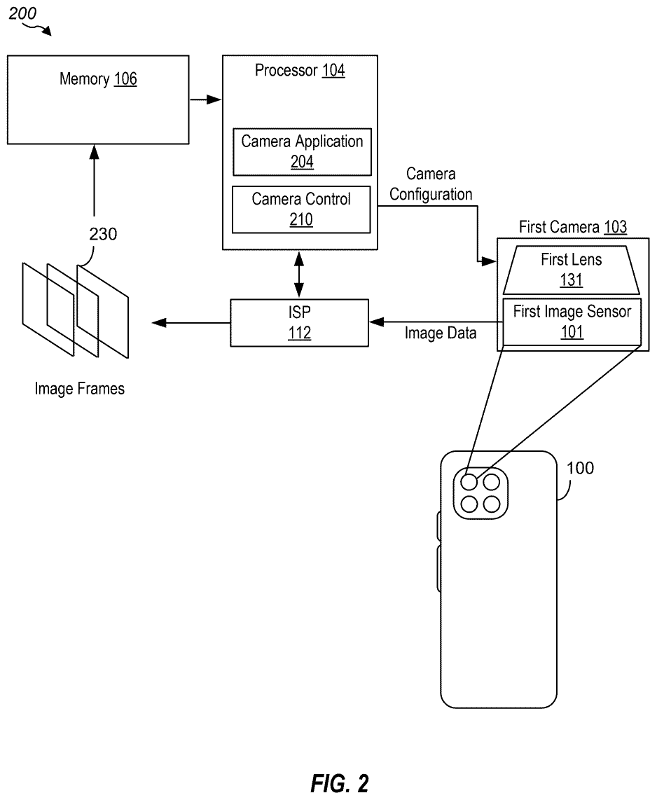

The exemplary image capture device of FIG. 1 may be operated to obtain improved images by reducing the latency of image stabilization using predicted image stabilization parameters. One example method of operating one or more cameras, such as camera 103, is shown in FIG. 2 and described below.

FIG. 2 is a block diagram illustrating an example data flow path for image data processing in an image capture device according to one or more embodiments of the disclosure. A processor 104 of system 200 may communicate with image signal processor (ISP) 112 through a bi-directional bus and/or separate control and data lines. The processor 104 may control camera 103 through camera control 210, such as for configuring the camera 103 through a driver executing on the processor 104. The camera control 210 may be managed by a camera application 204 executing on the processor 104, which provides settings accessible to a user such that a user can specify individual camera settings or select a profile with corresponding camera settings. The camera control 210 communicates with the camera 103 to configure the camera 103 in accordance with commands received from the camera application 204. The camera application 204 may be, for example, a photography application, a document scanning application, a messaging application, or other application that processes image data acquired from camera 103.

The camera configuration may parameters that specify, for example, a frame rate, an image resolution, a readout duration, an exposure level, an aspect ratio, an aperture size, etc. The camera 103 may obtain image data based on the camera configuration. For example, the processor 104 may execute a camera application 204 to instruct camera 103, through camera control 210, to set a first camera configuration for the camera 103, to obtain first image data from the camera 103 operating in the first camera configuration, to instruct camera 103 to set a second camera configuration for the camera 103, and to obtain second image data from the camera 103 operating in the second camera configuration.

In some embodiments in which camera 103 is a variable aperture (VA) camera system, the processor 104 may execute a camera application 204 to instruct camera 103 to configure to a first aperture size, obtain first image data from the camera 103, instruct camera 103 to configure to a second aperture size, and obtain second image data from the camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 is a larger aperture size than f/8.0.

The image data received from camera 103 may be processed in one or more blocks of the ISP 112 to form image frames 230 that are stored in memory 106 and/or provided to the processor 104. The processor 104 may further process the image data to apply effects to the image frames 230. Effects may include Bokeh, lighting, color casting, and/or high dynamic range (HDR) merging. In some embodiments, functionality may be embedded in a different component, such as the ISP 112, a DSP, an ASIC, or other custom logic circuit for performing the additional image processing.

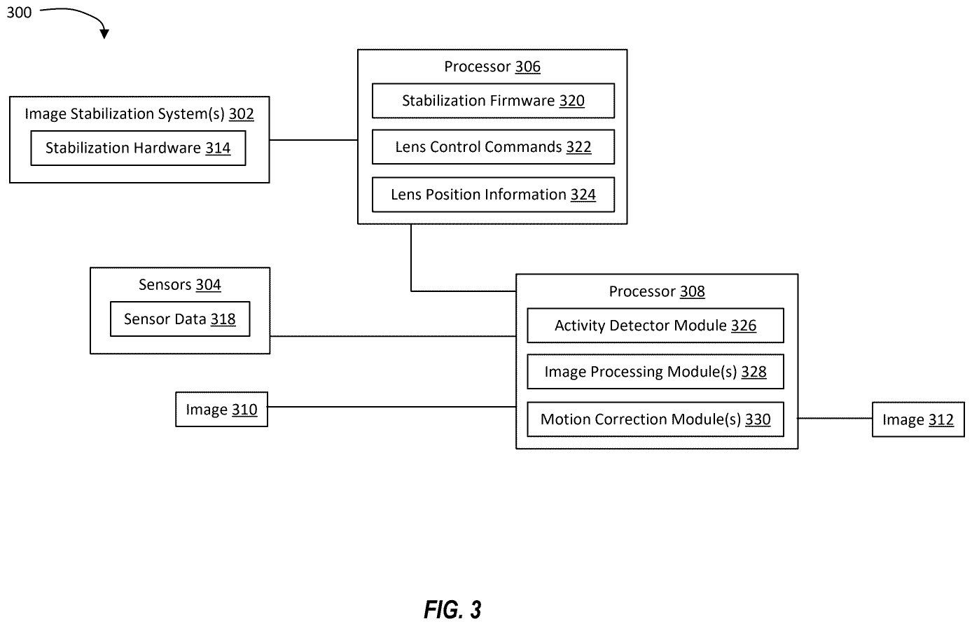

FIG. 3 depicts an image stabilization process 300 according to one aspect of the present disclosure. The system 300 includes an image stabilization system 302, which includes image stabilization hardware 314 (e.g., optical image stabilization hardware), which may be coupled to a corresponding image sensor. In certain implementations, the system 300 may include multiple image stabilization systems, which may each be coupled to a corresponding camera. The system 300 also includes sensors 304 capturing sensor data 318. The system 300 also includes a first processor 306, which includes image stabilization firmware 320, lens control commands 322, and lens position information 324. A second processor 308 receives an input image 310 and further includes an activity detector module 326, image processing module(s) 328, and motion correction module(s) 330. The second process 308 may determine an output image 312.

In certain implementations, the image stabilization process 300 may begin with the sensors 304 capturing sensor data 318 and providing the sensor data 318 to the first processor 306. One or more IMU sensors may provide motion-related data to a microcontroller. The sensors 304 may include gyroscopes and accelerometers that measure angular velocity and linear acceleration. The first processor 304, which may host OIS firmware, can continuously collect these this sensor data 318 and interpret the data 318 to estimate the current state of the device's motion.

In certain implementations, the first processor 308 may then generate, by the image stabilization firmware 320, appropriate lens control commands 322 to drive mechanical elements the image stabilization 314. For example, the image stabilization hardware 314 may include movable lenses, actuators, and/or corresponding feedback sensors that can be moved to adjust the optical path and compensate for device shake or vibration. The lens position and lens motion feedback from the hardware 314 may then be provided back to the first processor 306 the microcontroller so that the image stabilization firmware 320 can continuously refine and update commands in real time.

In certain implementations, the first processor 306, which may include the image stabilization firmware 320, may share aggregated data such as the lens position information 324, sensor data 318, or predictive estimates with the second processor 308. Communication between the first processor 306 and the second processor 308 may occur through shared memory buffers or via interrupt-driven methods. For instance, the first processor 306 may write updated lens position information 324 to a shared memory region, while the second processor 308 periodically reads these updates to perform higher-level processing. Additionally, the first processor 306 may continuously gather feedback from the image stabilization hardware 314—that is, information on how the movable lenses or actuators are currently positioned—and refine the lens control commands 322 in real time based on the latest sensor data 318.

In certain implementations, the activity detector module 326 may process portions of the sensor data 318 (e.g., IMU-related signals) or image-based data to classify the user's movement panning, or a combination thereof, such as walking or running. Based on these classifications, the image processing module(s) 328 or motion correction module(s) 330 may be configured to compensate for different levels of device motion. For example, the motion correction module(s) 330 may retrieve the lens position information 324 and employ warp or distortion-correction techniques on the input image 310, thereby stabilizing or reducing motion artifacts. The second processor 308 may thus combine activity information, lens position updates, and the input image 310 to produce an output image 312 with minimized blur or jitter.

Finally, the output image 312 from the motion correction module(s) 330 may be forwarded to a display path or a video recording path, ensuring that users see a stabilized view or that captured video footage remains stable. Along the way, additional processing steps (e.g., early cropping, face detection, high-dynamic-range merging, bokeh effects) can be applied, each potentially leveraging the sensor data 318 and the lens position information 324 as needed. In certain implementations, separate pipelines may be employed for low-latency correction (for preview) and higher-accuracy correction (for final output).

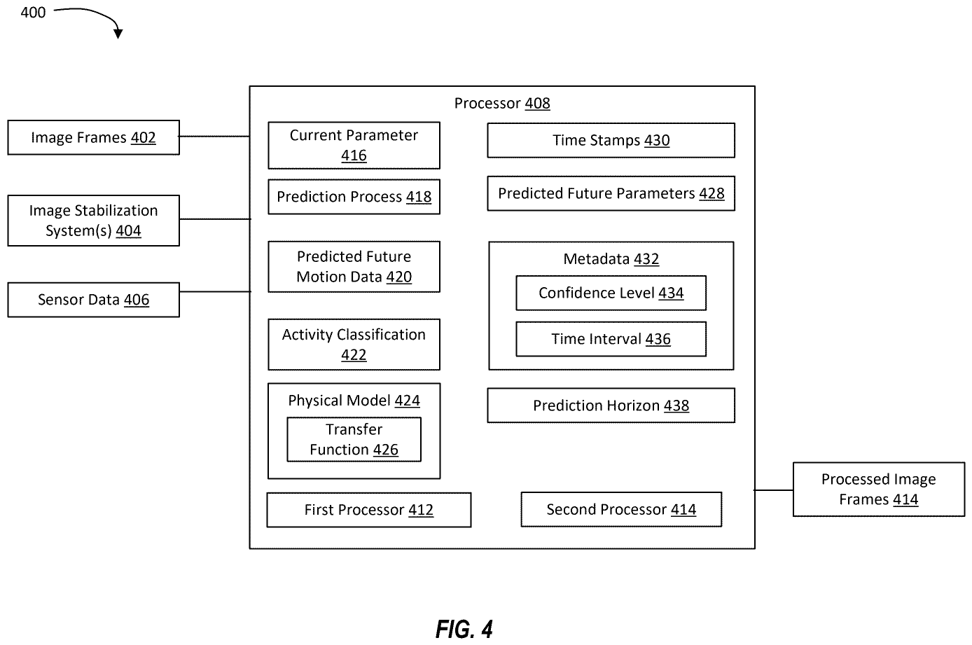

FIG. 4 depicts a system 400 for adaptive image processing using predicted image stabilization parameters according to one aspect of the present disclosure. The system 400 includes a processor 408 that receives image frames 402 and sensor data 406 and determines processed image frames 414. The system 400 also includes an image stabilization system 404 configured to compensate for unwanted device motion during image capture. The image stabilization system 404 may include components such as movable lenses, actuators, sensors, and control circuitry that physically adjust optical elements to counteract motion. In certain implementations, the image stabilization system 404 may be an optical image stabilization system. Additionally, although FIG. 4 only depicts a single image stabilization system 404, certain implementations may include multiple image stabilization systems, such as separate image stabilization systems for multiple cameras, which may be controlled using the techniques described herein. The processor 408 includes a current parameter 416 (e.g., a current position) of the image stabilization system 404, which may be received from position sensors within the system 404. The processor 408 also includes a prediction process 418, predicted future motion data 420, an activity classification 422, a physical model 424 of the image stabilization system 404, which may include a transfer function 426 representing the relationship between input commands and actual positions. The processor 408 further includes predicted future parameters 428 for the image stabilization system 404, along with associated time stamps 430 and metadata 432. The metadata 432 may include a confidence level 434 and a time distance 436 for the corresponding predicted future parameters 428. The processor 408 also includes a prediction horizon 438, representing the time interval into the future over which predictions are made. The processor 408 may also include a first processor 412 and a second processor 414, which may implement all or part of the functions discussed in connection with the processor 408. In certain implementations, the system 400 may be an exemplary implementation of the device 100.

In certain implementations, a processor 408 may be configured to receive sensor data 406 indicative of motion of an image capture device (such as the device 100) during a process to capture one or more image frames 402. The sensor data 406 may include measurements from one or more sensors communicatively coupled to and/or integrated within the image capture device (such as the device 100). The sensor data 406 may be communicated from the sensors to the processor 408 using one or more communication protocols or interfaces, such as an Inter-Integrated Circuit bus, a Serial Peripheral Interface (SPI), and the like. The processor 408 may access the sensor data 406 by periodically polling the sensors or by receiving data through interrupt-driven techniques when new sensor readings are available.

In certain implementations, the sensors may include gyroscopes, accelerometers, magnetometers, or a combination thereof. These sensors may provide real-time information about the device's movement and orientation, which is essential for accurately predicting motion during image capture. A gyroscope may refer to a sensor that measures the angular velocity of the image capture device around one or more axes. For example, a three-axis gyroscope may detect rotational movements such as pitch, roll, and yaw, providing data on how the device is tilting or turning during image acquisition. An accelerometer may include a sensor that measures linear acceleration forces acting on the device along the x, y, and z axes. This data may reveal movements such as shaking, swaying, or sudden shifts in position. A magnetometer may refer to a sensor that measures the strength and direction of magnetic fields, often used to determine the device's orientation relative to the Earth's magnetic north.

During image frame acquisition, the sensor data 406 may be captured concurrently with the image frames 402. In certain implementations, the sensors may sample data at high frequencies, such as 1,000 Hz or higher, to ensure fine-grained motion detection. The sampling rates of the sensors may be synchronized with the image capture rate to maintain temporal alignment between the sensor data 406 and the captured image frames 402. For example, time stamps may be associated with both sensor readings and image frames to accurately correlate motion data with specific frames.

In certain implementations, the processor 408 may be configured to determine, based at least in part on the sensor data 406, one or more predicted future parameters 428 for an image stabilization system 404 of the image capture device (such as the device 100). The image stabilization system 404 may include one or more mechanisms designed to compensate for unwanted device motion along one or more axes during image capture to reduce blur and improve stability.

In certain implementations, the image stabilization system 404 may include an optical image stabilization system. Optical image stabilization (OIS) refers to technology that compensates for camera shake by physically adjusting optical elements within the camera system. The components of an optical image stabilization system 404 may include movable lenses, actuators, sensors, and control circuitry. Movable lenses within the optical image stabilization system 404 may shift along one or more axes (such as the x, y, and/or z axes, or other axes according to alternative coordinate systems)to counteract unwanted motion detected by the sensor data 406. Actuators, such as voice coil motors or piezoelectric elements, may precisely control the movement of these lenses based on commands from the processor 408. The system may also include sensors that provide feedback on lens positions, enabling closed-loop control for accurate stabilization. In certain implementations, each lens carriage of the image stabilization system 404 may include Hall-effect position sensors whose readings are processed by a corresponding controller (such as an OIS micro-controller). Because Hall sensors may be susceptible to stray magnetic fields generated by other OIS axes, auto-focus coils, or external sources, the microcontroller may be configured to apply real-time electromagnetic-field compensation so that both raw and corrected lens-position values are available to the prediction process 418.

In additional or alternative implementations, the image stabilization system 404 may include an autofocus (AF) subsystem configured to translate a focus lens group along an optical z-axis to attain a target focus position. In certain implementations, the AF subsystem may include a motor that receives drive signals generated by the first processor 410 and a pair of position sensors (e.g., Hall Effect sensors) that return real-time axial position readings to the first processor 410.

To determine the predicted future parameters 428, the processor 408 may first determine predicted future motion data 420 of the image capture device based at least in part on the sensor data 406. The predicted future motion data 420 may include estimations of the device's future movements over a specified time interval, which may be referred to as a prediction horizon 438. By analyzing patterns in the sensor data 406, the processor 408 can anticipate how the device is likely to move in the immediate future.

To determine the predicted future motion data 420, the processor 408 may be configured to apply a prediction process 418 configured to estimate future motion data based on the sensor data 406. The prediction process 418 may include one or more computational processes or models that extrapolate future motion from historical sensor readings. In certain implementations, the prediction process 418 may utilize machine learning models, polynomial fitting, or signal prediction techniques. In certain implementations, when multiple IMU packages are present, the prediction process 418 may be configured to exploit the spatial relationships between the IMU packages. For example, if multiple IMU packages are mounted on a rigid body (such as dual camera modules in the same handset) a single six-degree-of-freedom rigid-body model can be determined once and the resulting orientation trajectory reused for every sensor stream. As another example, in distributed systems (such as wearable cameras on different body parts) the motion of an upstream body segment, such as the shoulder, can be used as a leading indicator for the future motion of a downstream segment, such as the elbow, thereby extending the effective prediction horizon for the downstream sensor.

In one example, the processor 408 may employ a machine learning model to predict future motion data 420. Machine learning models may refer to computational algorithms that learn patterns from data and can make predictions based on new inputs. The processor 408 may use historical sensor data 406 and corresponding motion outcomes to train the machine learning model. Features extracted from the sensor data 406 may include accelerations, velocities, orientations, and their temporal derivatives. In some implementations the processor 408 may be configured to determine several alternative motion hypotheses, which may each represent a plausible future trajectory, and may determine corresponding sets of predicted future parameters 428 for each motion hypothesis. During run time the processor 408 may be configured to select a hypothesis whose early samples best match newly arriving sensor data, which may enable near-zero-latency processing once the correct branch is identified.

In implementations where the machine learning model is a neural network, the processor 408 may utilize a neural network architecture designed for time-series prediction, such as a recurrent neural network (RNN) or a long short-term memory (LSTM) network. A neural network may include input layers that receive sensor data 406, hidden layers that process the information, and output layers that generate predicted future motion data 420. The network may use activation functions like ReLU (Rectified Linear Unit) or sigmoid functions to introduce non-linearity. The machine learning model may be trained using loss functions such as mean squared error to quantify the difference between predicted and actual motion, and optimization processes like gradient descent for adjusting network weights. The training dataset may comprise sensor readings collected during various user activities, ensuring the model can generalize across different motion patterns. For example, during walking scenarios, the model may be updated and trained to predict periodic motion patterns corresponding to footsteps.

Alternatively, in implementations where the machine learning model is a regression model, the processor 408 may implement processes such as linear regression, support vector regression, or decision trees. The input variables may include recent sensor readings and their statistical features, while the predicted output is the future motion data 420. The model training process may utilize regularization techniques such as Lasso (L1 regularization) or Ridge (L2 regularization) to prevent overfitting. For instance, if the processor 408 observes that the variance in accelerometer data 406 is high, indicating erratic movement, regularization helps the model focus on the most significant predictors. In certain implementations, the processor 408 may perform polynomial fitting on the sensor data 406 to predict future motion data 420. Polynomial fitting may include approximating the sensor data 406 with a polynomial equation of a predetermined degree. The degree of the polynomial may be selected based on the complexity of the motion pattern. For example, a higher-degree polynomial may capture more complex movements but may also introduce overfitting. Techniques like least squares minimization may be used to determine the polynomial coefficients, minimizing the error between the polynomial curve and the actual sensor data 406. For instance, the processor 408 may fit a third-degree polynomial to recent gyroscope readings to project rotational motion into the near future.

In certain implementations, the processor 408 may perform activity classification 422 of the image capture device (such as the device 100) based at least in part on the sensor data 406. Activity classification 422 may refer to identifying the user's current activityby analyzing motion patterns. In additional or alternative implementations, the activity classification 422 may include a classification of the panning behavior of the image capture device. Various motion scenarios may be encountered during image capture, each producing distinct sensor data patterns (such as stationary, walking, running, and the like). For example, in a steady hand scenario where the user holds the device as still as possible, the gyroscope and accelerometer readings may show minimal fluctuations, indicating negligible movement. In contrast, during a walking scenario, accelerometer data may exhibit periodic spikes corresponding to the impact of each footstep, while gyroscope data may show slight rotational movements as the device sways naturally. In a running scenario, both accelerometer and gyroscope readings may display higher amplitude variations due to increased movement intensity and rapid changes in orientation. By analyzing these patterns, the processor 408 can classify the current activity of the user. Certain scenarios, such as a constant-velocity pan, produce little dynamic acceleration and therefore cannot be reliably inferred from IMU data alone. The processor 408 may therefore augment the sensor-based features with image-domain motion cues extracted from previous frames (such as global-motion vectors obtained via block matching, phase-correlation offsets, or dense optical-flow fields) so that the activity classification 422 remains robust across IMU-silent scenarios.

The processor 408 may use statistical techniques or machine learning processes for activity classification 422. For example, the processor 408 may implement machine learning models such as decision trees, support vector machines, or neural networks trained on labeled sensor data 406 to recognize patterns indicative of specific activities. These models may extract features like mean acceleration, variance, and frequency components from the sensor data 406 to classify the user's activity accurately; additional features, such as sustained unidirectional angular velocity, may be used to classify slow or constant-speed panning. One exemplary design employs a dual-branch neural network in which an inertial branch ingests windowed accelerometer/gyroscope sequences and an image branch ingests frame-to-frame motion vectors. The latent outputs of the two branches may then be concatenated or otherwise fused to produce a unified activity classification.

In certain implementations, threshold-based criteria may be applied to features like the standard deviation or variance of the sensor data 406. For instance, if the variance of accelerometer readings exceeds a certain threshold, the processor 408 may classify the activity as running. In certain implementations, frequency analysis techniques like the Fast Fourier Transform (FFT) may also be used to detect periodicity in the sensor data 406, aiding in distinguishing between walking and running.

Determining the one or more predicted future parameters 428 may be further based on the activity classification 422. Different activities may affect the motion characteristics of the device, and the prediction process 418 may adjust parameters accordingly. For example, during stationary periods, the processor 408 may assume minimal movement and simplify the prediction process 418 for efficiency. In contrast, during running, the processor 408 may utilize more complex models or increase the prediction horizon 438 to account for rapid movements.

In certain implementations, the processor 408 may determine the predicted future parameters 428 by applying an image stabilization control process to the sensor data 406 and the predicted future motion data 420. The image stabilization control process may include processes or techniques that calculate the necessary adjustments for the image stabilization system 404 to counteract predicted motion. This may involve generating control signals or commands that direct the actuators within the image stabilization system 404.

In certain implementations, applying the image stabilization control process may include utilizing a physical model 424 of the image stabilization system 404. The physical model 424 may refer to a mathematical representation of the system's dynamics, incorporating physical characteristic parameters such as mass, damping coefficients, stiffness constants, and actuator response times. These parameters may be obtained from vendor data, calibration data during manufacturing or maintenance, or through adaptive processes that account for changes over time due to wear and tear, temperature variations, unit limits, and the like.

The physical model 424 may include a dynamic model accounting for system response characteristics of the image stabilization system 404, such as overshoot, oscillations, and response time. Overshoot may refer to the phenomenon where the system exceeds the desired position before settling, while oscillations are repeated variations around the target position. Response time may include the time taken for the system to reach and stabilize at the desired position. Relatedly, the physical model 424 may be configured to capture or otherwise account for interactions between OIS and AF systems of the image stabilization system, such as cross-axis interactions caused by common mechanical components of these systems.

Additionally, the physical model 424 may include a transfer function 426 representing the relationship between input commands to the image stabilization system 404 and actual positions achieved. The transfer function 426 may be derived in the frequency domain and may characterize how different frequencies in the input affect the system's output. Estimating the transfer function 426 may involve system identification techniques based on previous input commands and corresponding measured positions of the image stabilization system 404.

The processor 408 may apply specific input signals, such as step functions or sinusoidal inputs, and record the system's response. By analyzing the system's response to known inputs, such as the measured overshoot and oscillations following a step input, the processor 408 can estimate parameters like the system's gain, damping ratio, and natural frequency. For example, the processor 408 may be configured to derive the transfer function 426 using system identification techniques such as least squares estimation, recursive least squares, or autoregressive with exogenous input (ARX) models. These techniques assist in creating a mathematical model that accurately represents the dynamic behavior of the image stabilization system 404.

In certain implementations, the processor 408 may be configured to determine that a current parameter 416, a predicted future parameter 428, or a combination thereof for the image stabilization system 404 is within a threshold distance of an operational boundary of the image stabilization system 404. The current parameter 416 may refer to the present physical state of the image stabilization system 404, such as the position of one or more movable lenses or actuators of the image stabilization system 404. The processor 408 may determine the current parameter 416 by receiving one or more signals or measurements from position sensors within the image stabilization system 404.

The operational boundaries may refer to the physical limits of movement or adjustment that the image stabilization system 404 can achieve, such as maximum lens shift or tilt angles beyond which the system cannot compensate for motion. Detecting proximity to these boundaries is important to prevent the system from exceeding its capabilities, which could lead to reduced performance or mechanical stress. To detect proximity to operational boundaries, the processor 408 may evaluate the current parameter 416 and/or the predicted future parameters 428 relative to predefined operational limits of the image stabilization system 404. These operational limits may be specified by the manufacturer and may include parameters like maximum allowable displacements, rotational angles, or actuator positions. For example, if the image stabilization system 404 has a maximum lens shift of ±2 millimeters in any direction, the processor 408 may compare each predicted future position to this limit. If a predicted position is within a threshold distance, such as 0.2 millimeters, from the maximum limit, the processor 408 may determine that the system is near its operational boundary.

In response to detecting that the image stabilization system 404 is near its operational boundaries, the processor 408 may adjust the determination of the one or more predicted future parameters 428. In certain implementations, adjusting the determination may involve reducing a prediction horizon 438 when the system is near its operational boundaries. The prediction horizon 438 may refer to the time interval into the future over which the processor 408 predicts the parameters of the image stabilization system 404. By reducing the prediction horizon 438, the processor 408 focuses on short-term predictions, which may be more accurate when the system approaches its operational limits. Reducing the prediction horizon 438 may help prevent inaccurate predictions that could occur due to nonlinear behaviors or limitations in the physical model 424 when near operational boundaries. For instance, as the system approaches its maximum displacement, the dynamics may change, and the physical model 424 may become less reliable for long-term predictions. By shortening the prediction horizon 438, the processor 408 can rely on more immediate sensor data 406 and provide more precise control commands. In certain implementations, where the physical model 424 captures boundary-dependent overshoot and damping, the prediction process 418 may emulate or otherwise predict how the image-stabilization hardware will respond if a commanded position exceeds the limit and may, based on the emulation, select among multiple OIS control strategies stored in memory. For example, when the processor 408 detects a low-motion scene and the sensor exposure time is on the order of one to two seconds, the selected strategy may indicate nearly full compensation so that user-induced shake is minimized across the entire exposure. As another example, during high-motion video capture with exposure times of twenty to thirty milliseconds, the selected strategy may deliberately under-compensate individual frames and instead average residual blur over time, thereby avoiding frame-to-frame sharpness discontinuities. The processor 408 may embed the chosen control strategy into the predicted future parameters 428 so that downstream imaging blocks receive boundary-aware forecasts that are tuned to the current use case.

In additional or alternative implementations, adjusting the determination of the predicted future parameters 428 may involve increasing the frequency of parameter updates when the image stabilization system 404 is near its operational boundaries. For example, when the system detects rapid movement causing the image stabilization system 404 to approach its limits, the processor 408 may process sensor data 406 and update predictions at a higher rate, such as increasing from 1,000 Hz to 2,000 Hz. This allows the processor 408 to react more quickly to changes and maintain accurate predictions as the image stabilization system 404 approaches operational boundaries.

The processor 408 may be configured to determine a confidence level 434 associated with the one or more predicted future parameters 428. The confidence level 434 may refer to a quantitative measure of the reliability of the predictions made by the processor 408. In certain implementations, the confidence level 434 may be determined separately for each of the future parameters 428. In certain implementations, the confidence level 434 may be determined based on past prediction accuracy, movement characteristics derived from the sensor data 406, proximity to operational boundaries, uncertainties in the physical model 424, or a combination thereof. Past prediction accuracy may affect the confidence level 434 by providing historical data on how well previous predictions matched actual outcomes. If past predictions closely aligned with actual positions, the processor 408 may assign a higher confidence level 434 to current predictions. Conversely, if there were significant discrepancies, the confidence level 434 may be lowered. Movement characteristics derived from the sensor data 406, such as the rate of acceleration or rotational speed, may also impact the confidence level 434. Erratic or high-velocity movements may be more difficult to predict accurately, leading to a lower confidence level 434. For instance, sudden jerks detected by the accelerometer may indicate unpredictable motion, prompting the processor 408 to adjust the confidence level 434 accordingly. Proximity to operational boundaries may reduce the confidence level 434 because the image stabilization system 404 may exhibit nonlinear behavior near its limits, making predictions less reliable. Uncertainties in the physical model 424, such as unmodeled dynamics or parameter estimation errors, may also contribute to a lower confidence level 434. In certain implementations, the confidence level 434 may be determined as a weighted combination of one or more factors, such as one or more of the factors discussed above.

In certain implementations, determining the one or more predicted future parameters 428 may include determining a configurable number of predicted future parameters based on system requirements. For example, the number of predicted parameters may be adjusted to balance computational load and prediction accuracy. In certain implementations, the prediction horizon 438 may be determined based on latency requirements, computational resources, the desired level of motion compensation, or a combination thereof. System requirements may dictate the configuration by specifying acceptable latency thresholds or performance criteria. For instance, applications requiring real-time performance may increase the prediction horizon 438 to ensure processing completes processing as quickly as possible (e.g., based on earlier predicted future parameters 428), while offline processing tasks may use a shorter prediction horizon 438 for more accurate predictions (e.g., when latency concerns are reduced). Additionally or alternatively, offline processing tasks may be configured to disable the prediction of future parameters 428.

In certain implementations, the processor 408 may be configured to receive configuration data specifying the number of predicted future parameters 428 to determine. This configuration data may be received through interfaces or protocols such as API calls, configuration files, or user input. For example, an application running on the image capture device may send configuration data to the processor 408 indicating that a prediction horizon 438 of 200 milliseconds is desired, resulting in a specific number of predicted parameters based on the sensor sampling rate. The processor 408 may be configured to process the configuration data by adjusting parameters within the prediction process 418, such as buffer sizes, computation loops, or the granularity of predictions. For instance, increasing the number of predicted parameters may require more memory allocation and computational time, which the processor 408 must manage efficiently. In certain implementations, the configuration data may be determined based at least in part on the determined prediction accuracy. For example, the processor 408 may implement adaptive mechanisms that adjust prediction parameters based on accuracy metrics. As a particular example, if the processor 408 observes that prediction errors are increasing, it may reduce the prediction horizon 438 or decrease the number of predicted parameters to improve stability and accuracy. As another example, the processor 408 may be configured to monitor the average error between predicted parameters 428 and actual parameters over a time window. If the average error exceeds a predefined threshold, the processor 408 may update the configuration data to shorten the prediction horizon 438, thereby focusing on more immediate and accurate predictions. Conversely, if errors are minimal, the processor 408 may extend the prediction horizon 438 to enhance performance.

In certain implementations, the processor 408 may be configured to determine one or more processed image frames 414 based on the one or more predicted future parameters 428 and at least a subset of the one or more image frames 402. The processed image frames 414 may refer to image data that has been adjusted or enhanced using the predicted future parameters 428 to compensate for anticipated device motion, thereby improving image quality and stability. For example, the processor 408 may be configured to align a first image frame and a second image frame of the one or more image frames 402 based on the one or more parameters. Aligning frames may include computing, from the predicted future parameters, a spatial transform (e.g., translation, rotation, scaling, or warping) that maps pixel locations of the second image frame into correspondence with pixel locations of the first image frame so that scene content is aligned across the two frames despite intervening device motion. In additional or alternative implementations, the processed image frames 414 may refer to image data that has been processed to correct for distortions caused by rolling shutters, OIS, AF, defective pixel correction, and the like.

In certain implementations, the processor 408 may configured to determine an aligned first image frame and an aligned second image frame by aligning at least the first image frame and the second image frame. In such instances, the processor 408 may be configured to determine the one or more processed image frames by determining a fused image frame by applying a fusion process to the aligned first image frame and the aligned second image frame. For instance, the processor 408 or another processor may include a fusion sub-module within the image-processing module(s) 328 that receives an aligned first image frame and an aligned second image frame and produces a fused image frame. In certain implementations, the fusion process may include a multi-frame high-dynamic-range (MFHDR) process, a multi-frame noise reduction (MFNR) process, or a combination thereof. The MFHDR process may be configured to combine frames captured at different exposure values to extend dynamic range of the resulting fused image frame. The MFNR process may be configured to temporally averages corresponding pixels to suppress sensor noise.

In certain implementations, the processor 408 may be configured to adjust the processing of the processed image frames 414 based on whether the determined confidence level 434 associated with the predicted future parameters 428 satisfies a predetermined threshold. The confidence level 434 may influence processing decisions by indicating the reliability of the predicted parameters. When the confidence level 434 satisfies the threshold, the processor 408 may place greater trust in the predictions and proceed with processing without waiting for actual position data. Conversely, when the confidence level 434 does not satisfy the threshold, the processor 408 may opt to modify processing strategies to mitigate potential inaccuracies.

In certain implementations, the processor 408 may be configured to weight predicted data differently based on whether the confidence level 434 satisfies the predetermined threshold. For example, during image stabilization, the processor 408 may apply stronger correction adjustments to image frames 402 when the confidence level 434 satisfies the threshold, and more conservative adjustments when the confidence level 434 does not satisfy the threshold. This adaptive weighting ensures that processing remains robust under varying prediction reliability. As an example, if the processor 408 determines that the confidence level 434 satisfies the threshold during a stationary scenario where device motion is minimal, it may aggressively stabilize the image frames 402 using the predicted future parameters 428. In contrast, during erratic movement where the confidence level 434 does not satisfy the threshold, the processor 408 may reduce the extent of stabilization to prevent overcompensation that could degrade image quality.

In certain implementations, when the confidence level 434 satisfies a predetermined threshold, the processor 408 may determine the processed image frames 414 based on the predicted future parameters 428 without waiting for actual parameters. Processing with high-confidence predictions allows for reduced latency, enabling real-time image stabilization and improved user experience. For instance, during smooth camera movements with high confidence levels, the processor 408 may continuously process image frames 402 using predicted parameters 428, providing immediate stabilization effects in live previews or video recording.

In certain implementations, when the confidence level 434 does not satisfy a predetermined threshold, the processor 408 may delay the determination of the processed image frames 414 until actual parameters of the image stabilization system 404 are available. For instance, if the confidence level 434 does not satisfy the predetermined threshold during sudden, unpredictable movements—such as when the user rapidly shifts the device—the processor 408 may delay processing the image frames 402 until actual parameters are available. By doing so, the processor 408 avoids applying potentially inaccurate stabilization based on unreliable predictions, thereby maintaining image quality and stabilization. Delaying processing may impact system performance by introducing latency, as the processor 408 waits for actual position data before proceeding. This trade-off prioritizes accuracy over speed, ensuring that image quality is not compromised by relying on low-confidence predictions. In certain implementations, If subsequent actual parameters reveal that an earlier high-confidence prediction exceeds an allowable error tolerance, the processor 408 may be configured to retrospectively re-process the affected image frames 414 using the actual parameters or an updated prediction to suppress artifacts introduced by the mis-prediction.

In certain implementations, the processor 408 may be configured to receive actual parameters of the image stabilization system 404 corresponding to the predicted future parameters 428. The actual parameters may be received through communication interfaces between the image stabilization system 404 and the processor 408, such as shared memory regions or interrupt-driven signals. Timing considerations may be used to align the actual parameters with the corresponding image frames 402 and predicted parameters 428. For example, the processor 408 may use time stamps 430 associated with each data point to align and correlate the information accurately. Upon receiving actual parameters, the processor 408 may update previous predictions or adjust ongoing processing. If discrepancies are detected between predicted parameters 428 and actual parameters, the processor 408 may refine the physical model 424 or adjust the prediction process 418 to improve future predictions. For example, if the processor 408 detects discrepancies between predicted parameters 428 and actual parameters, it may adjust the parameters of the physical model 424, such as updating the damping coefficient to better reflect observed system behavior. As another example, the processor 408 may modify the prediction process 418 by selecting a different prediction technique or recalibrating the model using recent sensor data 406 to improve future predictions.

In additional or alternative implementations, the processor 408 may update the processed image frames 414 based at least in part on the actual parameters. Updating the processed frames may include applying correction or refinement techniques to enhance image quality. For example, the processor 408 may adjust the stabilization parameters, re-process certain frames, or apply post-processing filters to compensate for any inaccuracies in the initial predictions. For instance, the processor 408 may adjust stabilization parameters by recalculating motion vectors based on the actual parameters and applying refined corrections to subsequent image frames 414. As another example, the processor 408 may re-process certain frames by re-aligning them using the actual parameters and reapplying image enhancement techniques to correct any artifacts introduced due to initial prediction inaccuracies.

The processor 408 may be configured to determine prediction accuracy by comparing the predicted future parameters 428 with the corresponding actual parameters received. Prediction accuracy may be measured using metrics such as mean squared error (MSE), root mean squared error (RMSE), or absolute error values. These metrics quantify the differences between predicted and actual parameters, providing insights into the performance of the prediction process 418. Accuracy measurements may be stored in memory for analysis and utilized to inform adjustments in the system. The processor 408 may maintain historical accuracy data to identify trends or patterns in prediction performance under different conditions.

Based on the determined prediction accuracy, the processor 408 may adjust the number of predicted future parameters 428 to determine, effectively adapting the prediction horizon 438 to optimize performance. Processes or rules governing adjustments may include predefined thresholds for acceptable error levels, or adaptive algorithms that continuously fine-tune parameters. For example, if the processor 408 finds that prediction accuracy decreases beyond a certain horizon, it may shorten the prediction horizon 438 to focus on more reliable short-term predictions. Conversely, if accuracy remains high over longer horizons, the processor 408 may extend the prediction horizon 438 to enhance proactive compensation.

In certain implementations, determining the processed image frames 414 may include adjusting one or more image processing components within the processor 408 (such as the image signal processor ISP 112) prior to the availability of actual parameters of the image stabilization system 404 based on the predicted future parameters 428. These components may include specific processing blocks responsible for tasks such as demosaicing, image scaling, distortion correction, and color conversion. By configuring these blocks in advance using the predicted parameters 428, the processor 408 ensures that the image processing components are prepared to process incoming image frames 402 with reduced latency.

As one particular example, the processor 408 may include a component or block within the configured to perform temporal noise reduction on the processed image frames 414 using the predicted future parameters 428. Temporal noise reduction may involve comparing and averaging pixel values across multiple frames, requiring precise alignment of frames to be effective. By utilizing the predicted parameters 428 to align frames before applying noise reduction filters, the processor 408 enhances the effectiveness of the noise reduction process. For instance, prior to receiving actual parameters, the processor 408 may configure temporal noise reduction parameters within the ISP 112 based on the predicted parameters 428, enabling immediate and accurate noise reduction as image frames 402 are captured.

The processor 408 may also employ other image processing components within the ISP 112 to enhance image quality based on the predicted future parameters 428. These components may include processes such as temporal averaging, motion-compensated filtering, or spatiotemporal denoising. By compensating for predicted motion, the processor 408 can maintain pixel correspondence across frames, resulting in cleaner images with reduced noise artifacts. For example, in low-light conditions where image noise is prominent, the processor 408 may use predicted parameters 428 to align consecutive frames within the ISP 112 and average the pixel values. This reduces random noise by leveraging redundant information, producing a clearer image. In additional or alternative implementations, the processor 408 may be configured to ensure temporal consistency in image processing tasks such as segmentation, depth estimation, or high dynamic range (HDR) imaging. Accurate alignment based on predicted parameters 428 allows these processes to function effectively, resulting in more precise outputs like detailed depth maps and consistent HDR images. In additional or alternative implementations, the processor 408 may be configured to provide motion-compensated frames to additional processing tasks, such as machine-learning-based processes executing within the ISP 112. In one particular implementations, the additional processing tasks may include a face-detection process. In such implementations, alignment performed with the predicted future parameters 428 may allow the face-detection process to commence inference immediately upon frame arrival, maintaining a substantially constant processing delay even when the number of faces present in the scene changes from frame to frame.

By configuring the image processing components in advance using the predicted parameters 428, the processor 408 can reduce latency and improve real-time performance. Early configuration allows the processing pipeline, including the ISP 112, to be prepared for incoming image frames 402, minimizing delays associated with dynamic adjustments. Components involved may include setting up transformation matrices for image stabilization, loading correction parameters, or adjusting filter settings. This proactive approach ensures that when image frames 402 arrive, the system can process the image frames 402 immediately without incurring additional setup time, resulting in smoother real-time previews and recordings.

Although depicted and discussed above as a single processor 408, in certain implementations, the image capture device (such as the device 100) may utilize multiple processors to perform all or some of the above-discussed functions. In certain implementations, determining the one or more predicted future parameters 428 may be performed by a first processor 412, while determining the one or more processed image frames 414 may be performed by a second processor 414 different from the first processor 412. In such instances, the first processor 412 may be a microcontroller or other processor configured to control all or part of the image stabilization system 404. As a microcontroller associated with the image stabilization system 404, the first processor 412 may have direct access to the sensor data 406 and may perform real-time processing to compute predicted future parameters 428. The second processor 414 may be part of a high-level operating system executing on the image capture device, such as the processor 104, the ISP 112, or a combination thereof.

In certain implementations, the first processor 412 and the second processor 414 may communicate via a predefined application programming interface (API). The API may define the protocols, data structures, and function calls used for data exchange between the processors. This communication ensures synchronization and coordination of tasks across different processing units. The API may include data structures that encapsulate the predicted future parameters 428 generated by the first processor 412. The data structure may comprise time stamps 430 corresponding to each predicted future parameter 428, predicted parameter data corresponding to the time stamps 430, and metadata 432 associated with each predicted future parameter 428. The metadata 432 may include information such as an indication that the predicted future parameter 428 is extrapolated, a time interval 436 from the last actual parameter of the image stabilization system 404, and a confidence level 434 associated with the predicted future parameter 428.

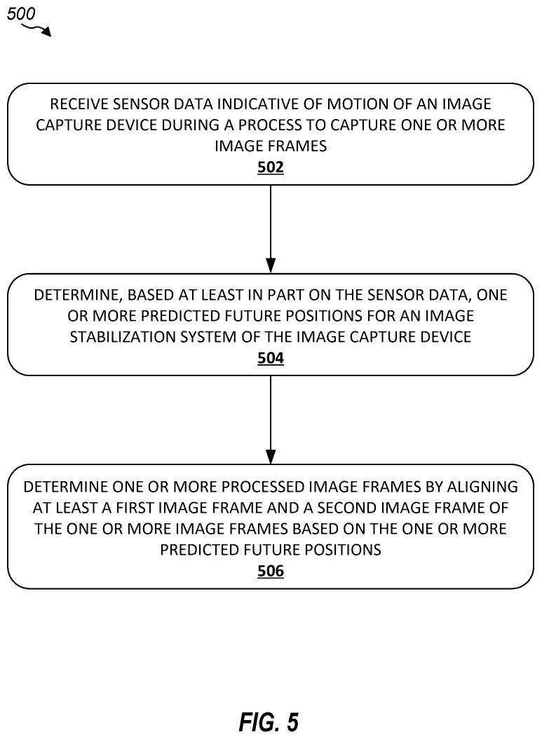

FIG. 5 depicts a method 500 for adaptive image processing using predicted image stabilization parameters according to one aspect of the present disclosure. The method 500 may be implemented on a computer system, such as one or more of the systems 200, 400. The method 500 may also be implemented by a set of instructions stored on a computer-readable medium that, when executed by a processor, cause the computing device to perform the method 500. Although the examples below are described with reference to the flowchart illustrated in FIG. 5, many other methods of performing the acts associated with FIG. 5 may be used. For example, the order of some of the blocks may be changed, certain blocks may be combined with other blocks, one or more of the blocks may be repeated, and some of the blocks may be optional.

At block 502, the method 500 may include receiving sensor data indicative of motion of an image capture device during a process to capture one or more image frames. For example, the processor 408 may receive sensor data 406 indicative of motion of the image capture device during a process to capture one or more image frames 402. In certain implementations, the sensor data 406 may indicate motion of one or more cameras or image sensors within the image capture device.

At block 504, the method 500 may include determining, based at least in part on the sensor data, one or more predicted future parameters for an image stabilization system of the image capture device. For example, the processor 408 may determine, based at least in part on the sensor data 406, one or more predicted future parameters 428 for an image stabilization system 404 of the image capture device. In certain implementations, the image stabilization system 404 may include a single image stabilization system for a single camera. In additional or alternative implementations, the image stabilization system 404 may include multiple image stabilization systems for multiple cameras.

In certain implementations, determining the one or more predicted future parameters may include determining predicted future motion data of the image capture device based at least in part on the sensor data, and determining the one or more predicted future parameters based at least in part on the predicted future motion data. In certain implementations, the method 500 may further include determining an activity classification of the image capture device based at least in part on the sensor data, wherein determining the predicted future parameters is based at least in part on the activity classification.

In certain implementations, determining the one or more predicted future parameters may involve applying an image stabilization control process associated with the image stabilization system to the sensor data. In certain implementations, applying the image stabilization control process may be performed at least in part based on a physical model 424 of the image stabilization system, wherein the physical model 424 may include a transfer function 426 representing a relationship between input commands to the image stabilization system 404 and actual parameters of the image stabilization system 404.

At block 506, the method 500 may include determining one or more processed image frames by aligning at least a first image frame and a second image frame of the one or more image frames based on the one or more predicted future parameters. For example, the processor 408 may determine one or more processed image frames 414 by aligning at least a first image frame and a second image frame of the one or more image frames based on the one or more predicted future parameters 428.

In certain implementations, the method 500 may further include determining that a current parameter 416, a predicted future parameter 428, or a combination thereof for the image stabilization system 404 is within a threshold distance of an operational boundary of the image stabilization system 404, and adjusting the determination of the one or more predicted future parameters in response to determining that the current parameter, the predicted future parameter, or the combination thereof is within the threshold distance of the operational boundary of the image stabilization system 404. In certain implementations, adjusting the determination of the one or more predicted future parameters may include reducing a prediction horizon 438 for the predicted future parameters increasing a frequency of parameter updates for the predicted future parameters or a combination thereof.

In certain implementations, the method 500 may further include determining a confidence level 434 associated with the one or more predicted future parameters 428, determining that the confidence level 434 does not satisfy a predetermined threshold, and delaying determination of the one or more processed image frames 414 until actual parameters of the image stabilization system 404 are available in response to determining that the confidence level 434 does not satisfy the predetermined threshold. Alternatively, in certain implementations, the method 500 may include determining a confidence level 434 associated with the one or more predicted future parameters 428, determining that the confidence level 434 satisfies a predetermined threshold, and determining the one or more processed image frames 414 based on the one or more predicted future parameters 428 prior to determining actual parameters of the image stabilization system 404 in response to determining that the confidence level 434 satisfies the predetermined threshold.

In certain implementations, the method 500 may further include determining actual parameters of the image stabilization system 404 corresponding to the one or more predicted future parameters 428, determining a prediction accuracy by comparing the one or more predicted future parameters 428 with the corresponding actual parameters, and adjusting the number of predicted future parameters 428 to determine based at least in part on the determined prediction accuracy.

In certain implementations, determining the one or more predicted future parameters 428 may be performed by a first processor 412 of the image capture device, and determining the one or more processed image frames 414 may be performed by a second processor 414 of the image capture device different from the first processor 412. In certain implementations, the first processor 412 may be a microcontroller associated with the image stabilization system 404, and the second processor 414 may be associated with a high-level operating system executing on the image capture device. In certain implementations, the first processor 412 and the second processor 414 may communicate via a predefined application programming interface. In certain implementations, the first processor 412 may communicate the one or more predicted future parameters 428 to the second processor 414 in a data structure comprising time stamps 430 corresponding to the one or more predicted future parameters 428, predicted parameter data corresponding to the time stamps 430, and metadata 432 associated with each predicted future parameter 428, and the metadata 432 may include at least one of an indication that the predicted future parameter 428 is extrapolated, a time distance 436 from a last actual parameter of the image stabilization system 404, and a confidence level 434 associated with the predicted future parameter 428.

In certain implementations, the processor 408 may configured to determine an aligned first image frame and an aligned second image frame by aligning at least the first image frame and the second image frame. In such instances, the processor 408 may be configured to determine the one or more processed image frames by determining a fused image frame by applying a fusion process to the aligned first image frame and the aligned second image frame. In certain implementations, the fusion process may include a multi-frame high-dynamic-range (MFHDR) process, a multi-frame noise reduction (MFNR) process, or a combination thereof.

In one or more aspects, techniques for supporting image processing may include additional aspects, such as any single aspect or any combination of aspects described below or in connection with one or more other processes or devices described elsewhere herein.

In a first aspect, a system includes a memory and at least one processor coupled to the memory, the at least one processor configured to receive sensor data indicative of motion of an image capture device during a process to capture one or more image frames, determine, based at least in part on the sensor data, one or more predicted future parameters for an image stabilization system of the image capture device, and determine one or more processed image frames by aligning at least a first image frame and a second image frame of the one or more image frames based on the one or more predicted future parameters.

Additionally, the system may perform or operate according to one or more aspects as described below. In some implementations, the apparatus includes a wireless device, such as a UE. In some implementations, the apparatus includes a remote server, such as a cloud-based computing solution, which receives image data for processing to determine output image frames. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect according to the first aspect, the processor is further configured to determine an aligned first image frame and an aligned second image frame by aligning at least the first image frame and the second image frame, and to determine the one or more processed image frames by determining a fused image frame by applying a fusion process to the aligned first image frame and the aligned second image frame.

In a third aspect according to the second aspect, the fusion process comprises a multi-frame high-dynamic-range (MFHDR) process, a multi-frame noise reduction (MFNR) process, or a combination thereof.

In a fourth aspect according to any one of the first through third aspects, the at least one processor is configured to determine the one or more predicted future parameters by determining predicted future motion data of the image capture device based at least in part on the sensor data, and determining the one or more predicted future parameters based at least in part on the predicted future motion data.

In a fifth aspect according to the fourth aspect, the at least one processor is further configured to determine an activity classification of the image capture device based at least in part on the sensor data, and determining the predicted future parameters is based at least in part on the activity classification.

In a sixth aspect according to any one of the first through fifth aspects, the at least one processor is configured to determine the one or more predicted future parameters by applying an image stabilization control process associated with the image stabilization system to the sensor data.

In a seventh aspect according to the sixth aspect, the at least one processor is configured to apply the image stabilization control process at least in part based on a physical model of the image stabilization system, wherein the physical model comprises a transfer function representing a relationship between input commands to the image stabilization system and actual parameters of the image stabilization system.

In an eighth aspect according to any one of the first through seventh aspects, the at least one processor is further configured to determine that a current parameter, a predicted future parameter, or a combination thereof for the image stabilization system is within a threshold distance of an operational boundary of the image stabilization system, and adjust the determination of the one or more predicted future parameters in response to determining that the current parameter, the predicted future parameter, or the combination thereof is within the threshold distance of the operational boundary of the image stabilization system.

In a ninth aspect according to the eighth aspect, the at least one processor is further configured to adjust the determination of the one or more predicted future parameters by reducing a prediction horizon for the predicted future parameters, increasing a frequency of parameter updates for the predicted future parameters, or a combination thereof.

In a tenth aspect according to any one of the first through ninth aspects, the at least one processor is further configured to determine a confidence level associated with the one or more predicted future parameters, determine that the confidence level does not satisfy a predetermined threshold, and delay determination of the one or more processed image frames until actual parameters of the image stabilization system are available in response to determining that the confidence level does not satisfy the predetermined threshold.

In an eleventh aspect according to any one of the first through tenth aspects, the at least one processor is further configured to determine a confidence level associated with the one or more predicted future parameters, determine that the confidence level satisfies a predetermined threshold, and determine the one or more processed image frames based on the one or more predicted future parameters prior to determining actual parameters of the image stabilization system in response to determining that the confidence level satisfies the predetermined threshold.

In a twelfth aspect according to any one of the first through eleventh aspects, the at least one processor is further configured to determine actual parameters of the image stabilization system corresponding to the one or more predicted future parameters, determine a prediction accuracy by comparing the one or more predicted future parameters with the corresponding actual parameters, and adjust a number of predicted future parameters to determine based at least in part on the determined prediction accuracy.

In a thirteenth aspect according to any one of the first through twelfth aspects, the at least one processor comprises a first processor configured to determine the one or more predicted future parameters, and a second processor configured to determine the one or more processed image frames.

In a fourteenth aspect according to the thirteenth aspect, the first processor is a microcontroller associated with the image stabilization system, the second processor is associated with a high-level operating system executing on the image capture device, or a combination thereof.

In a fifteenth aspect according to any one of the thirteenth through fourteenth aspects, the first processor and the second processor communicate via a predefined application programming interface.

In a sixteenth aspect according to the fifteenth aspect, the first processor communicates the one or more predicted future parameters to the second processor in a data structure comprising time stamps corresponding to the one or more predicted future parameters, predicted parameter data corresponding to the time stamps, and metadata associated with each predicted future parameter, the metadata comprising at least one of an indication that the predicted future parameter is extrapolated, a time interval from a last actual parameter of the image stabilization system, and a confidence level associated with the predicted future parameter.

In a seventeenth aspect, a method includes receiving sensor data indicative of motion of an image capture device during a process to capture one or more image frames, determining, based at least in part on the sensor data, one or more predicted future parameters for an image stabilization system of the image capture device, and determining one or more processed image frames by aligning at least a first image frame and a second image frame of the one or more image frames based on the one or more predicted future parameters.

In an eighteenth aspect according to the seventeenth aspect, determining the one or more predicted future parameters includes determining predicted future motion data of the image capture device based at least in part on the sensor data, and determining the one or more predicted future parameters based at least in part on the predicted future motion data.

In a nineteenth aspect according to the seventeenth aspect, determining the one or more predicted future parameters includes applying an image stabilization control process associated with the image stabilization system to the sensor data, wherein applying the image stabilization control process is performed at least in part based on a physical model of the image stabilization system, and the physical model comprises a transfer function representing a relationship between input commands to the image stabilization system and actual parameters of the image stabilization system.

In a twentieth aspect, a non-transitory computer-readable medium stores instructions which, when executed by a processor, cause the processor to receive sensor data indicative of motion of an image capture device during a process to capture one or more image frames, determine, based at least in part on the sensor data, one or more predicted future parameters for an image stabilization system of the image capture device, and determine one or more processed image frames by aligning at least a first image frame and a second image frame of the one or more image frames based on the one or more predicted future parameters.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-4 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 3-5 may be combined with one or more blocks (or operations) described with reference to another of the figures. For example, one or more blocks (or operations) of FIG. 4 may be combined with one or more blocks (or operations) of FIGS. 1-3. As another example, one or more blocks associated with FIG. 5 may be combined with one or more blocks (or operations) associated with FIGS. 1-4.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes . 1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A system comprising:
a memory; and
at least one processor coupled to the memory, the at least one processor configured to:
receive sensor data indicative of motion of an image capture device during a process to capture one or more image frames;
determine, based at least in part on the sensor data, one or more predicted future parameters for an image stabilization system of the image capture device; and
determine one or more processed image frames by aligning at least a first image frame and a second image frame of the one or more image frames based on the one or more predicted future parameters.

2. The system of claim 1, wherein the processor is further configured to determine an aligned first image frame and an aligned second image frame by aligning at least the first image frame and the second image frame, and
wherein the processor is further configured to determine the one or more processed image frames by determining a fused image frame by applying a fusion process to the aligned first image frame and the aligned second image frame.

3. The system of claim 2, wherein the fusion process comprises a multi-frame high-dynamic-range (MFHDR) process, a multi-frame noise reduction (MFNR) process, or a combination thereof.

4. The system of claim 1, wherein the at least one processor is configured to determine the one or more predicted future parameters by:
determining predicted future motion data of the image capture device based at least in part on the sensor data; and
determining the one or more predicted future parameters based at least in part on the predicted future motion data.

5. The system of claim 4, wherein the at least one processor is further configured to determine an activity classification of the image capture device based at least in part on the sensor data, and wherein determining the predicted future parameters is based at least in part on the activity classification.

6. The system of claim 1, wherein the at least one processor is configured to determine the one or more predicted future parameters by applying an image stabilization control process associated with the image stabilization system to the sensor data.

7. The system of claim 6, wherein the at least one processor is configured to apply the image stabilization control process at least in part based on a physical model of the image stabilization system, and wherein the physical model comprises a transfer function representing a relationship between input commands to the image stabilization system and actual parameters of the image stabilization system.

8. The system of claim 1, wherein the at least one processor is further configured to:
determine that a current parameter, a first predicted future parameter of the one or more future parameters, or a combination thereof for the image stabilization system is within a threshold distance of an operational boundary of the image stabilization system; and
adjust the determination of the one or more predicted future parameters in response to determining that the current parameter, the predicted future parameter, or the combination thereof is within the threshold distance of the operational boundary of the image stabilization system.

9. The system of claim 8, wherein the at least one processor is further configured to adjust the determination of the one or more predicted future parameters by reducing a prediction horizon for the predicted future parameters, increasing a frequency of parameter updates for the predicted future parameters, or a combination thereof.

10. The system of claim 1, wherein the at least one processor is further configured to:
determine a confidence level associated with the one or more predicted future parameters;
determine that the confidence level does not satisfy a predetermined threshold; and
delay determination of the one or more processed image frames until actual parameters of the image stabilization system are available in response to determining that the confidence level does not satisfy the predetermined threshold.

11. The system of claim 1, wherein the at least one processor is further configured to:
determine a confidence level associated with the one or more predicted future parameters;
determine that the confidence level satisfies a predetermined threshold; and
determine the one or more processed image frames based on the one or more predicted future parameters prior to determining actual parameters of the image stabilization system in response to determining that the confidence level satisfies the predetermined threshold.

12. The system of claim 1, wherein the at least one processor is further configured to:
determine actual parameters of the image stabilization system corresponding to the one or more predicted future parameters;
determine a prediction accuracy by comparing the one or more predicted future parameters with corresponding actual parameters; and
adjust a number of predicted future parameters to determine based at least in part on the determined prediction accuracy.

13. The system of claim 1, wherein the at least one processor comprises:
a first processor configured to determine the one or more predicted future parameters; and
a second processor configured to determine the one or more processed image frames.

14. The system of claim 13, wherein the first processor is a microcontroller associated with the image stabilization system, the second processor is associated with a high-level operating system executing on the image capture device, or a combination thereof.

15. The system of claim 13, wherein the first processor and the second processor communicate via a predefined application programming interface.

16. The system of claim 15, wherein the first processor communicates the one or more predicted future parameters to the second processor in a data structure comprising:
time stamps corresponding to the one or more predicted future parameters;
predicted parameter data corresponding to the time stamps; and
metadata associated with each predicted future parameter, the metadata comprising at least one of:
an indication that the predicted future parameter is extrapolated;
a time interval from a last actual parameter of the image stabilization system; and
a confidence level associated with the predicted future parameter.

17. A method comprising:
receiving sensor data indicative of motion of an image capture device during a process to capture one or more image frames;
determining, based at least in part on the sensor data, one or more predicted future parameters for an image stabilization system of the image capture device; and
determining one or more processed image frames by aligning at least a first image frame and a second image frame of the one or more image frames based on the one or more predicted future parameters.

18. The method of claim 17, wherein determining the one or more predicted future parameters comprises:
determining predicted future motion data of the image capture device based at least in part on the sensor data; and
determining the one or more predicted future parameters based at least in part on the predicted future motion data.

19. The method of claim 17, wherein determining the one or more predicted future parameters comprises applying an image stabilization control process associated with the image stabilization system to the sensor data, wherein applying the image stabilization control process is performed at least in part based on a physical model of the image stabilization system, wherein the physical model comprises a transfer function representing a relationship between input commands to the image stabilization system and actual parameters of the image stabilization system.

20. A non-transitory computer-readable medium storing instructions which, when executed by a processor, cause the processor to:
receive sensor data indicative of motion of an image capture device during a process to capture one or more image frames;
determine, based at least in part on the sensor data, one or more predicted future parameters for an image stabilization system of the image capture device; and
determine one or more processed image frames by aligning at least a first image frame and a second image frame of the one or more image frames based on the one or more predicted future parameters.
